(19) United States
(12) Patent Application Publication
(10) Pub. No.: US 2022/0279435 A1
(43) Pub. Date: Sep. 1, 2022

(54) LOW LATENCY SWITCHING BETWEEN SECONDARY NODES

(71) Applicant: QUALCOMM Incorporated, San Diego, CA (US)

(72) Inventors: Peng CHENG, Beijing (CN); Karthika PALADUGU, San Diego, CA (US); Gavin Bernard HORN, La Jolla, CA (US); Punyaslok PURKAYASTHA, San Diego, CA (US); Masato KITAZOE, Tokyo (JP); Ozcan OZTURK, San Diego, CA (US); Huichun LIU, Beijing (CN)

(21) Appl. No.: 17/597,711

(22) PCT Filed: Aug. 15, 2019
(86) PCT No.: PCT/CN2019/100752

§ 371 Date: Jan. 19, 2022

(51) Int. Cl. H04W 48/20; H04L 5/00; H04W 36/00

(52) U.S. Cl. CPC H04W 48/20; H04L 5/0035; H04W 36/0069

(57) ABSTRACT

This disclosure provides systems, methods, and apparatuses for low latency switching between a plurality of secondary nodes (SNs) based on a configuration for the plurality of the SNs provided to a user equipment (UE). In one aspect, the UE may obtain measurements for the plurality of the SNs according to the configuration during dual connectivity communications with a master node (MN). The MN or the UE may facilitate switching between the plurality of the SNs based on the measurements.

### TECHNICAL FIELD

Aspects of the present disclosure relate generally to wireless communication, and more particularly to techniques for low latency switching between secondary nodes.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink (DL) and uplink (UL). The DL (or forward link) refers to the communication link from the BS to the UE, and the UL (or reverse link) refers to the communication link from the UE to the BS. As will be described in more detail herein, a BS may be referred to as a NodeB, an LTE evolved nodeB (eNB), a gNB, an access point (AP), a radio head, a transmit receive point (TRP), a New Radio (NR) BS, a 5G NodeB, or the like.

The above multiple access technologies have been adopted in various telecommunication standards to provide a common protocol that enables different UEs to communicate on a municipal, national, regional, and even global level. NR, which also may be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency-division multiplexing (OFDM) with a cyclic prefix (CP) (CP-OFDM) on the DL, using CP-OFDM or SC-FDM (for example, also known as discrete Fourier transform spread OFDM (DFT-s-OFDM)) on the UL (or a combination thereof), as well as supporting beamforming, multiple-input multiple-output (MIMO) antenna technology, and carrier aggregation.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method of wireless communication performed by a user equipment (UE). The method may include receiving a configuration for a plurality of secondary nodes (SNs) that are candidates to provide dual connectivity with a master node (MN); receiving a command to communicate via an SN of the plurality of the SNs; and communicating via the MN and the SN.

In some aspects, the configuration identifies a measurement configuration for each respective SN of the plurality of the SNs. In some aspects, the method can include transmitting RRM measurements associated with the plurality of the SNs to enable the MN to select the SN for activation. In some aspects, the method can include receiving an updated configuration for a plurality of SNs that are candidates to provide dual connectivity with the MN based on the RRM measurements, and the updated configuration identifies resources, associated with a contention-free random access channel procedure, for each respective SN of the plurality of the SNs.

In some aspects, the configuration identifies a measurement condition that is to cause a request to activate a particular SN of the plurality of the SNs. In some aspects, the method can include transmitting a request to activate the SN based on a determination that a measurement condition for activating a particular SN of the plurality of the SNs is satisfied, and the command to communicate via the SN is based on the request. In some aspects, the request identifies a particular beam of the SN.

In some aspects, the command to communicate via the SN is received prior to a role switch between the MN and the SN. In some aspects, the method can include transmitting an indication of radio link failure in the SN, and receiving a command to communicate via another SN of the plurality of the SNs.

In some aspects, the method can include obtaining measurements associated with at least one of a remainder of the SNs of the plurality of the SNs while communicating via the MN and the SN. In some aspects, the measurements are at least one of radio resource management measurements or radio link monitoring measurements.

Another innovative aspect of the subject matter described in this disclosure can be implemented in a UE for wireless communication. The UE may include memory and one or more processors operatively coupled to the memory. The memory and the one or more processors may be configured to receive a configuration for a plurality of SNs that are candidates to provide dual connectivity with an MN; receive a command to communicate via an SN of the plurality of the SNs; and communicate via the MN and the SN.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a UE, may cause the one or more processors to receive a configuration for a plurality of SNs that are candidates to provide dual connectivity with an MN; receive a command to communicate via an SN of the plurality of the SNs; and communicate via the MN and the SN.

Another innovative aspect of the subject matter described in this disclosure can be implemented in an apparatus for wireless communication. The apparatus may include means for receiving a configuration for a plurality of SNs that are candidates to provide dual connectivity with an MN; means for receiving a command to communicate via an SN of the plurality of the SNs; and means for communicating via the MN and the SN.

Another innovative aspect of the subject matter described in this disclosure can be implemented in an apparatus for wireless communication. The apparatus for wireless communication may include a first interface to receive a configuration for a plurality of SNs that are candidates to provide dual connectivity with an MN; a second interface to receive a command to communicate via an SN of the plurality of the SNs; and a third interface to communicate via the MN and the SN.

Another innovative aspect of the subject matter described in this disclosure can be implemented in a method of wireless communication performed by a base station (BS) that is an MN. The method may include transmitting, to a UE, a configuration for a plurality of SNs that are candidates to provide dual connectivity with the MN; causing activation of an SN of the plurality of the SNs for dual connectivity with the MN; and transmitting, to the UE, a command to communicate via the SN of the plurality of the SNs.

In some aspects, the configuration identifies a measurement configuration for each respective SN of the plurality of the SNs. In some aspects, the method can include receiving RRM measurements associated with the plurality of the SNs, and causing activation of the SN is based on the RRM measurements. In some aspects, the method can include transmitting an updated configuration for a plurality of SNs that are candidates to provide dual connectivity with the MN based on the RRM measurements, and the updated configuration identifies resources, associated with a contention-free random access channel procedure, for each respective SN of the plurality of the SNs.

In some aspects, the configuration identifies a measurement condition that is to cause a request to activate a particular SN of the plurality of the SNs. In some aspects, the method can include receiving a request to activate the SN, and causing activation of the SN is based on the request. In some aspects, the request identifies a particular beam of the SN.

In some aspects, the command to communicate via the SN is transmitted prior to a role switch between the MN and the SN.

In some aspects, the method can include receiving an indication of radio link failure in the SN, causing activation of another SN of the plurality of the SNs, and transmitting a command to communicate via the other SN of the plurality of the SNs. In some aspects, the method can include causing deactivation of another SN of the plurality of the SNs prior to causing activation of the SN.

In some aspects, the method can include transmitting a request to a CU to configure the plurality of the SNs for dual connectivity with the MN. In some aspects, the method can include receiving information associated with the plurality of the SNs from the central unit, and the configuration is based on the information.

Another innovative aspect of the subject matter described in this disclosure can be implemented in a BS that is an MN for wireless communication. The BS that is the MN may include memory and one or more processors operatively coupled to the memory. The memory and the one or more processors may be configured to transmit, to a UE, a configuration for a plurality of SNs that are candidates to provide dual connectivity with the MN; cause activation of an SN of the plurality of the SNs for dual connectivity with the MN; and transmit, to the UE, a command to communicate via the SN of the plurality of the SNs.

Another innovative aspect of the subject matter described in this disclosure can be implemented in a non-transitory computer-readable medium. The non-transitory computer-readable medium may store one or more instructions for wireless communication. The one or more instructions, when executed by one or more processors of a BS that is an MN, may cause the one or more processors to transmit, to a UE, a configuration for a plurality of SNs that are candidates to provide dual connectivity with the MN; cause activation of an SN of the plurality of the SNs for dual connectivity with the MN; and transmit, to the UE, a command to communicate via the SN of the plurality of the SNs.

Another innovative aspect of the subject matter described in this disclosure can be implemented in an apparatus for wireless communication. The apparatus for wireless communication may include means for transmitting, to a UE, a configuration for a plurality of SNs that are candidates to provide dual connectivity with an MN; means for causing activation of an SN of the plurality of the SNs for dual connectivity with the MN; and means for transmitting, to the UE, a command to communicate via the SN of the plurality of the SNs.

Another innovative aspect of the subject matter described in this disclosure can be implemented in an apparatus for wireless communication. The apparatus for wireless communication may include a first interface to transmit, to a UE, a configuration for a plurality of SNs that are candidates to provide dual connectivity with an MN; a second interface to cause activation of an SN of the plurality of the SNs for dual connectivity with the MN; and a third interface to transmit, to the UE, a command to communicate via the SN of the plurality of the SNs.

Aspects generally include a method, apparatus, system, computer program product, non-transitory computer-readable medium, user equipment, base station, wireless communication device, and/or processing system as substantially described herein with reference to and as illustrated by the accompanying drawings.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a block diagram conceptually illustrating an example of a wireless network.

FIG. 2 is a block diagram conceptually illustrating an example of a base station in communication with a user equipment (UE) in a wireless network.

FIG. 3 is a diagram illustrating an example of configuring low latency switching between secondary nodes.

FIGS. 4 and 5 are diagrams illustrating examples of low latency switching between secondary nodes.

FIG. 6 is a diagram illustrating an example process performed, for example, by a UE.

FIG. 7 is a diagram illustrating an example process performed, for example, by a base station (BS).

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving radio frequency signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Some wireless communication systems permit dual connectivity of a user equipment (UE) to a network. For example, with dual connectivity, the UE may connect to the network via a master cell group (MCG), which may include one or more serving cells associated with a master node (MN), and a secondary cell group (SCG), which may include one or more serving cells associated with a secondary node (SN). Dual connectivity via the MN and the SN may enable improved connectivity, coverage area, and bandwidth for the UE. However, in dual connectivity, the UE may switch between SNs (for example, as the UE moves throughout a coverage area of the MN). In current wireless communication systems, switching between SNs involves releasing a source SN being used for the dual connectivity and adding, according to an addition procedure, a target SN that is to be used for the dual connectivity. In some cases, the addition procedure may be inefficient and cause substantial latency of dual connectivity communications. Moreover, this inefficiency may be exacerbated in communications in a millimeter wave (mmW) band, where frequent switching due to fluctuating channel quality is common. Some aspects described herein provide techniques and apparatuses for low latency switching between SNs.

Particular implementations of the subject matter described in this disclosure can be implemented to realize one or more of the following potential advantages. In some aspects, the techniques and apparatuses described herein provide a procedure for configuring multiple SNs (a plurality of SNs may include multiple SNs) for dual connectivity with an MN, thereby eliminating the need to perform an SN addition procedure for each SN switch. In addition, a configuration for the multiple SNs may be provided to the UE and retained by the UE during dual connectivity communications with the MN, thereby facilitating more efficient switching between the multiple SNs by the UE. Moreover, the configuration for the multiple SNs may include respective bearer configurations for the multiple SNs such that there is no packet data convergence protocol (PDCP) anchor change when switching SNs, thereby further improving the efficiency of switching between the multiple SNs. Furthermore, the techniques and apparatuses described herein provide a procedure in which the UE may monitor signal qualities of the multiple SNs without engaging in data transmissions with the multiple SNs, thereby reducing a power consumption of the UE and conserving network resources.

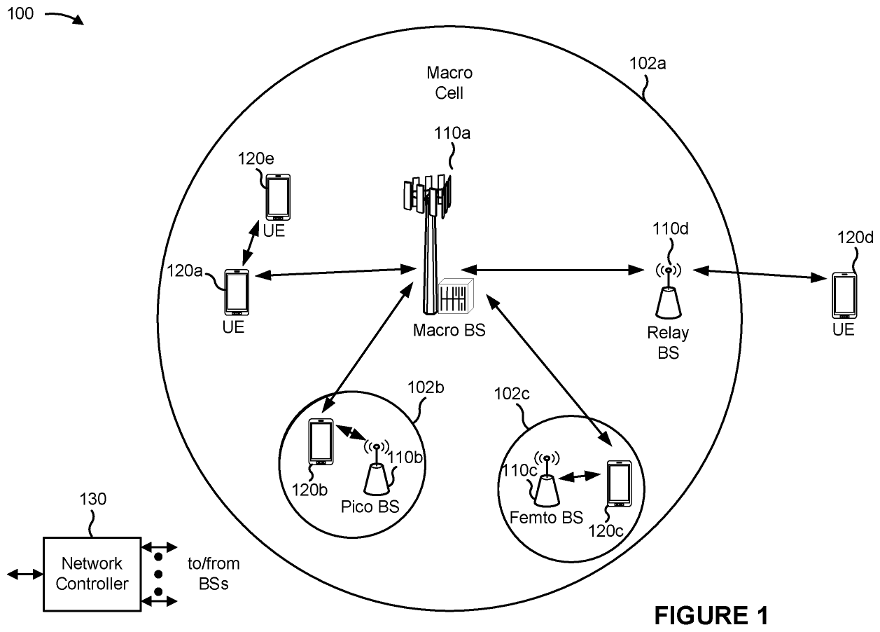

FIG. 1 is a block diagram conceptually illustrating an example of a wireless network 100. The wireless network 100 may be an LTE network or some other wireless network, such as a 5G or NR network. Wireless network 100 may include a number of BSs 110 (shown as BS 110a, BS 110b, BS 110c, and BS 110d) and other network entities. A BS is an entity that communicates with UEs and also may be referred to as a base station, a NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS, a BS subsystem serving this coverage area, or a combination thereof, depending on the context in which the term is used.

ABS may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. ABS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not necessarily be stationary, and the geographic area of the cell may move according to the location of a mobile BS. In some examples, the BSs may be interconnected to one another as well as to one or more other BSs or network nodes (not shown) in the wireless network 100 through various types of backhaul interfaces, such as a direct physical connection, a virtual network, or a combination thereof using any suitable transport network.

Wireless network 100 also may include relay stations. A relay station is an entity that can receive a transmission of data from an upstream station (for example, a BS or a UE) and send a transmission of the data to a downstream station (for example, a UE or a BS). A relay station also may be a UE that can relay transmissions for other UEs. In the example shown in FIG. 1, a relay station 110d may communicate with macro BS 110a and a UE 120d in order to facilitate communication between BS 110a and UE 120d. A relay station also may be referred to as a relay BS, a relay base station, a relay, etc.

Wireless network 100 may be a heterogeneous network that includes BSs of different types, for example, macro BSs, pico BSs, femto BSs, relay BSs, etc. These different types of BSs may have different transmit power levels, different coverage areas, and different impacts on interference in wireless network 100. For example, macro BSs may have a high transmit power level (for example, 5 to 40 Watts) whereas pico BSs, femto BSs, and relay BSs may have lower transmit power levels (for example, 0.1 to 2 Watts).

A network controller 130 may couple to a set of BSs and may provide coordination and control for these BSs. Network controller 130 may communicate with the BSs via a backhaul. The BSs also may communicate with one another, for example, directly or indirectly via a wireless or wireline backhaul.

UEs 120 (for example, 120a, 120b, 120c) may be dispersed throughout wireless network 100, and each UE may be stationary or mobile. A UE also may be referred to as an access terminal, a terminal, a mobile station, a subscriber unit, a station, etc. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, etc., that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. Some UEs may be considered a Customer Premises Equipment (CPE). UE 120 may be included inside a housing that houses components of UE 120, such as processor components, memory components, similar components, or a combination thereof.

In general, any number of wireless networks may be deployed in a given geographic area. Each wireless network may support a particular RAT and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between wireless networks of different RATs. In some cases, NR or 5G RAT networks may be deployed.

In some examples, access to the air interface may be scheduled, where a scheduling entity (for example, a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some examples, a UE may function as a scheduling entity, scheduling resources for one or more subordinate entities (for example, one or more other UEs). In this example, the UE is functioning as a scheduling entity, and other UEs utilize resources scheduled by the UE for wireless communication. A UE may function as a scheduling entity in a peer-to-peer (P2P) network, in a mesh network, or another type of network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the UE 120 may perform scheduling operations, resource selection operations, as well as other operations described elsewhere herein as being performed by the base station 110.

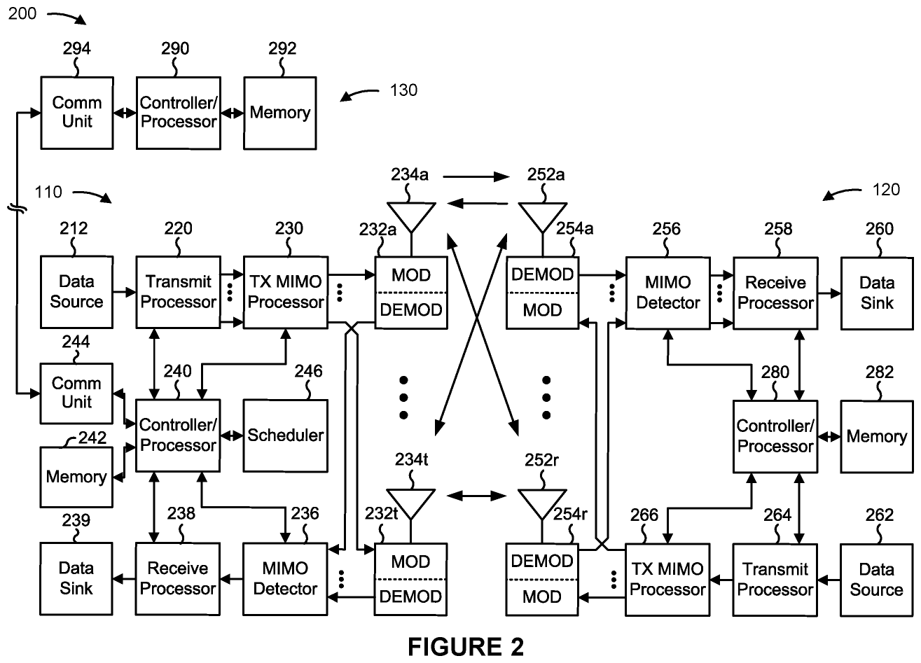

FIG. 2 is a block diagram conceptually illustrating an example 200 of a base station 110 in communication with a UE 120. In some aspects, base station 110 and UE 120 may respectively be one of the base stations and one of the UEs in wireless network 100 of FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. The transmit processor 220 also may process system information (for example, for semi-static resource partitioning information (SRPI), etc.) and control information (for example, CQI requests, grants, upper layer signaling, etc.) and provide overhead symbols and control symbols. The transmit processor 220 also may generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide T output symbol streams to T modulators (MODs) 232a through 232t. Each modulator 232 may process a respective output symbol stream (for example, for OFDM, etc.) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for UE 120 to a data sink 260, and provide decoded control information and system information to a controller or processor (controller/processor) 280. A channel processor may determine reference signal received power (RSRP), received signal strength indicator (RSSI), reference signal received quality (RSRQ), channel quality indicator (CQI), etc. In some aspects, one or more components of UE 120 may be included in a housing.

On the uplink, at UE 120, a transmit processor 264 may receive and process data from a data source 262 and control information (for example, for reports including RSRP, RSSI, RSRQ, CQI, etc.) from controller/processor 280. Transmit processor 264 also may generate reference symbols for one or more reference signals. The symbols from transmit processor 264 may be precoded by a TX MIMO processor 266 if applicable, further processed by modulators 254a through 254r (for example, for DFT-s-OFDM, CP-OFDM, etc.), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to a controller or processor (i.e., controller/processor) 240. The base station 110 may include communication unit 244 and communicate to network controller 130 via communication unit 244. The network controller 130 may include communication unit 294, a controller or processor (i.e., controller/processor) 290, and memory 292.

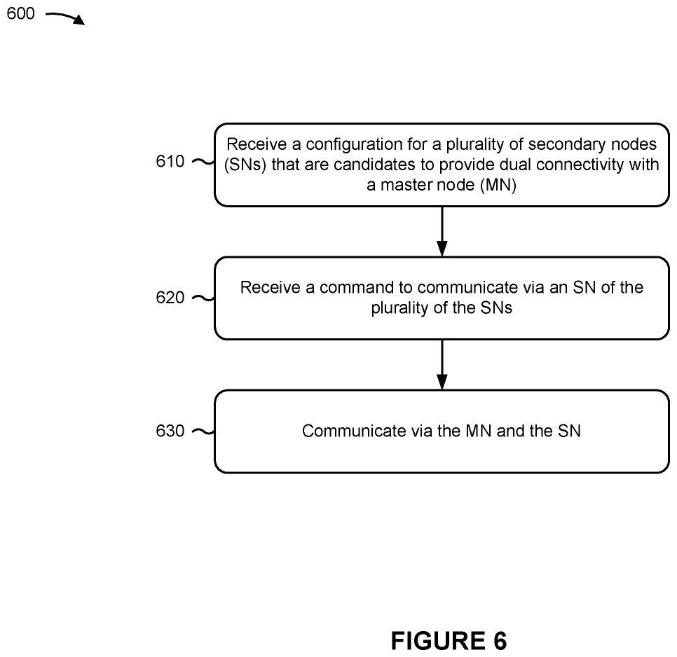

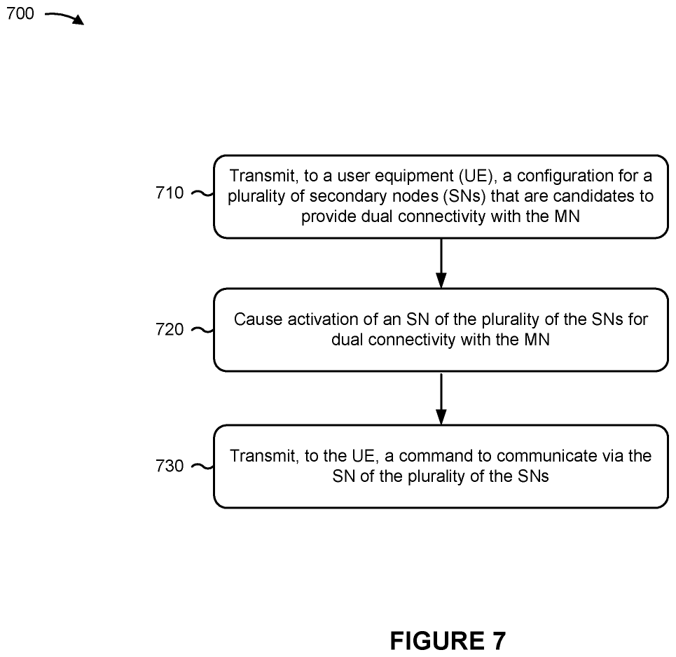

The controller/processor 240 of base station 110, the controller/processor 280 of UE 120, or any other component(s) of FIG. 2 may perform one or more techniques associated with low latency switching between multiple SNs, as described in more detail elsewhere herein. For example, the controller/processor 240 of base station 110, the controller/processor 280 of UE 120, or any other component(s) (or combinations of components) of FIG. 2 may perform or direct operations of, for example, process 600 of FIG. 6, process 700 of FIG. 7, or other processes as described herein. The memories 242 and 282 may store data and program codes for base station 110 and UE 120, respectively.

The stored program codes, when executed by the controller/processor 280 or other processors and modules at UE 120, may cause the UE 120 to perform operations described with respect to process 600 of FIG. 6, or other processes as described herein. The stored program codes, when executed by the controller/processor 240 or other processors and modules at base station 110, may cause the base station 110 to perform operations described with respect to process 700 of FIG. 7, or other processes as described herein. A scheduler 246 may schedule UEs for data transmission on the downlink, the uplink, or a combination thereof.

In some aspects, the UE 120 may include means for receiving a configuration for a plurality of SNs that are candidates to provide dual connectivity with an MN, means for receiving a command to communicate via an SN of the plurality of the SNs, means for communicating via the MN and the SN, or combinations thereof. In some aspects, such means may include one or more components of the UE 120 described in connection with FIG. 2. For example, UE 120 may include a first interface providing means for receiving a configuration for a plurality of SNs that are candidates to provide dual connectivity with an MN, a second interface providing means for receiving a command to communicate via an SN of the plurality of the SNs, a third interface providing means for communicating via the MN and the SN, or combinations thereof.

In some aspects, the base station 110 may include means for transmitting, to a UE, a configuration for a plurality of SNs that are candidates to provide dual connectivity with the MN, means for causing activation of an SN of the plurality of the SNs for dual connectivity with the MN, means for transmitting, to the UE, a command to communicate via the SN of the plurality of the SNs, or combinations thereof. In some aspects, such means may include one or more components of the base station 110 described in connection with FIG. 2. For example, base station 110 may include a first interface providing means for transmitting, to a UE, a configuration for a plurality of SNs that are candidates to provide dual connectivity with the MN, a second interface providing means for causing activation of an SN of the plurality of the SNs for dual connectivity with the MN, a third interface providing means for transmitting, to the UE, a command to communicate via the SN of the plurality of the SNs, or combinations thereof.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, the TX MIMO processor 266, or another processor may be performed by or under the control of controller/processor 280.

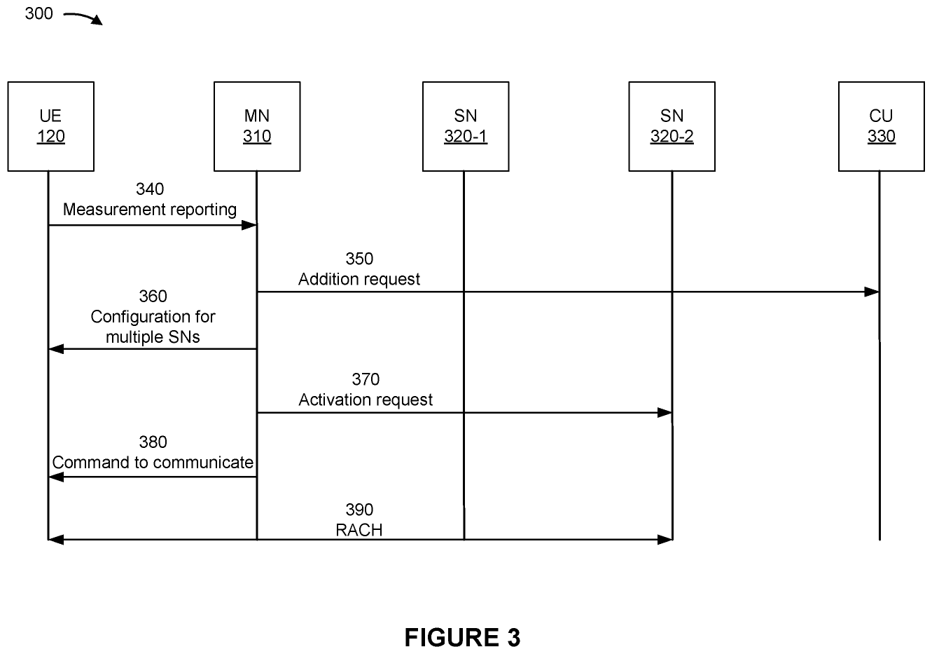

FIG. 3 is a diagram illustrating an example 300 of configuring low latency switching between SNs. As shown in FIG. 3, an MN 310 may configure a UE 120 for dual connectivity to a network via the MN 310 and one of multiple SNs 320. The multiple SNs 320 may include a target SN 320-1, which may be activated in a switch between SNs, and a source SN 320-2, which may be inactivated in a switch between SNs. In some aspects, SN 320-1 may be the source SN and SN 320-2 may be the target SN.

As shown in FIG. 3, the MN 310 may communicate with a central unit (CU) 330 of the network in order to configure the multiple SNs 320 for dual connectivity with the MN 310. In some aspects, one or more of the MN 310, the multiple SNs 320, and the CU 330 may be a base station, such as a base station 110. For example, the MN 310 may be a first base station 110, the multiple SNs 320 may be second base stations 110, and the CU 330 may be a third base station 110.

As shown by reference number 340, the UE 120 may transmit, and the MN 310 may receive, one or more measurement reports. In some aspects, the UE 120 may transmit the measurement reports in response to a message from the MN 310 that identifies multiple SNs 320 as candidates for dual connectivity with the MN 310. In some aspects, the UE 120 may transmit the measurement reports pursuant to a configuration of the multiple SNs 320 for the UE 120, as described in more detail below in connection with reference number 350.

The measurement reports may include measurements of one or more parameters relating to the multiple SNs 320. For example, the measurement reports may include respective radio resource management (RRM) measurements (for example, reference signal received power (RSRP) measurements, reference signal received quality (RSRQ) measurements, signal-to-noise ratio (SNR) measurements, signal-to-interference-plus-noise ratio (SINR) measurements) for the multiple SNs 320. As another example, the measurement reports may include respective radio link monitoring (RLM) measurements for the multiple SNs 320.

As shown by reference number 350, the MN 310 may transmit, and the CU 330 may receive, an addition request relating to the multiple SNs 320 in order to cause the CU 330 to prepare the multiple SNs 320 for dual connectivity with the MN 310. In some aspects, the addition request may include information relating to the measurement reports received from the UE 120, in order to enable the CU 330 to select the multiple SNs 320 as candidates for dual connectivity with the MN 310. Alternatively, the MN 310 may select the multiple SNs 320 as candidates for dual connectivity with the MN 310 (based on the measurement reports), and the addition request may identify the multiple SNs 320 selected. In some aspects, preparing an SN 320 for dual connectivity with the MN 310 includes configuring a bearer for communications between the UE 120 and the SN 320.

In some aspects, such as when the MN 310 and the multiple SNs 320 are distributed units (DUs) associated with the CU 330, the addition request transmitted by the MN 310 may be an F1 setup message that initiates an F1 procedure for preparing the multiple SNs 320 for dual connectivity with the MN 310. In such a case, the F1 setup message may include the information relating to the measurement reports received from the UE 120. Based on the F1 setup message, the CU 330 may configure (for example, configure UE 120 context) the multiple SNs 320 for dual connectivity with the MN 310. Moreover, the CU 330 may transmit (for example, via an RRCReconfiguration message) upon configuration of the multiple SNs 320, and the MN 310 may receive, a configuration for the multiple SNs 310-1, 310-2.

In some aspects, such as when the multiple SNs 320 are DUs associated with the CU 330, and the MN 310 is a DU associated with another CU, the addition request transmitted by the MN 310 may be a 5G secondary next generation NodeB (SgNB) addition request that initiates an SgNB addition procedure for preparing the multiple SNs 320 for dual connectivity with the MN 310. In such a case, the SgNB addition request may identify a configuration for the multiple SNs 320. Based on the SgNB setup message, the CU 330 may configure (for example, configure UE 120 context) the multiple SNs 320 for dual connectivity with the MN 310.

In some aspects, such as when the multiple SNs 320 are DUs associated with the CU 330, and the MN 310 is a DU associated with another CU, the MN 310 may transmit respective addition requests to the multiple SNs 320. For example, the MN 310 may select the SN 320-1 and the SN 320-2 as candidates for dual connectivity with the MN 310 based on the measurement reports received from the UE 120, and may transmit a first SgNB addition request to the SN 320-1 and a second SgNB addition request to the SN 320-2.

As shown by reference number 360, the MN 310 may transmit (for example, via an RRCReconfiguration message), and the UE 120 may receive, a configuration for the multiple SNs 320 (for example, a configuration for secondary cell groups (SCGs) respectively associated with the multiple SNs 320). For example, after the multiple SNs 320 are configured to provide dual connectivity with the MN 310, the MN 310 may transmit a configuration for the multiple SNs 320 to the UE 120. The configuration may identify the multiple SNs 320 as candidates to provide dual connectivity with the MN 310. The configuration may include information that identifies an SN 320 (for example, information that identifies a configured bearer of the SN 320).

The configuration for the multiple SNs 320 may enable the UE 120 to switch between the multiple SNs 320 during dual connectivity communications involving the MN 310 with reduced latency. For example, the UE 120 may retain the configuration for the multiple SNs 320 during dual connectivity communication involving the MN 310 in order to efficiently switch to an activated one of the multiple SNs 320 (with respect to the UE 120) while a remainder of the multiple SNs 320 remain inactive (with respect to the UE 120).

In some aspects, the configuration may identify resources, associated with a contention-free RACH procedure, for each respective SN 320 of the multiple SNs 320. In some aspects, the configuration for the multiple SNs 320 may identify a measurement configuration for each respective SN 320 of the multiple SNs 320. For example, a measurement configuration may identify a schedule at which the UE 120 is to obtain RRM measurements or RLM measurements for an SN 320 of the multiple SNs 320. In some aspects, a periodicity identified in a measurement configuration, and used to obtain RRM measurements from an inactive SN 320, may be different (longer) than a periodicity used to obtain RRM measurements from an active SN 320. Additionally, a quantity of samples identified in a measurement configuration, and used to obtain RRM measurements from an inactive SN 320, may be different (less) than a quantity of samples used to obtain RRM measurements from an active SN 320.

In some aspects, the configuration for the multiple SNs 320 may identify a measurement condition upon which the UE 120 is to request an SN switch between the multiple SNs 320. For example, the measurement condition may include one or more threshold values for one or more RRM measurements. As an example, the measurement condition may indicate that the UE 120 is to transmit a request to switch to an inactive target SN 320-1 when a particular RRM measurement (for example, RSRP, RSRQ, SNR, SINR) for an active source SN 320-2 falls below a threshold value. Additionally, or alternatively, the measurement condition may indicate that the UE 120 is to transmit a request to switch to an inactive target SN 320-1 when a particular RRM measurement (for example, RSRP, RSRQ, SNR, SINR) for the inactive target SN 320-1 exceeds a threshold value.

As shown by reference number 370, the MN 310 may transmit an initial activation request to one of the multiple SNs 320 identified in the configuration provided to the UE 120. As shown in FIG. 3, the MN 310 may transmit the initial activation request to the source SN 320-2, thereby causing activation of the source SN 320-2 for dual connectivity with the MN 310. The MN 310 may transmit the initial activation request to the source SN 320-2 based on the measurement report provided by the UE 120 (for example, based on a determination that the source SN 320-2 is providing a stronger signal to the UE 120 than any other of the multiple SNs 320).

As shown by reference number 380, the MN 310 may transmit (for example via downlink control information (DCI), radio resource control (RRC) signaling, or a medium access control (MAC) control element (MAC-CE)), and the UE 120 may receive, a command to communicate via the activated source SN 320-2. For example, the MN 310 may transmit a command to the UE 120 to communicate via the activated source SN 320-2 simultaneously with, or contemporaneously with, causing initial activation of the source SN 320-2 (by the initial activation request). As shown by reference number 390, the UE 120, in response to the command, may perform a random access channel (RACH) procedure to establish a connection with the activated source SN 320-2. For example, the UE 120 may perform a RACH procedure to establish a connection with the activated source SN 320-2 based on receiving the command to communicate via the activated source SN 320-2. Accordingly, the UE 120 may establish dual connectivity to the network via the MN 310 and the source SN 320-2.

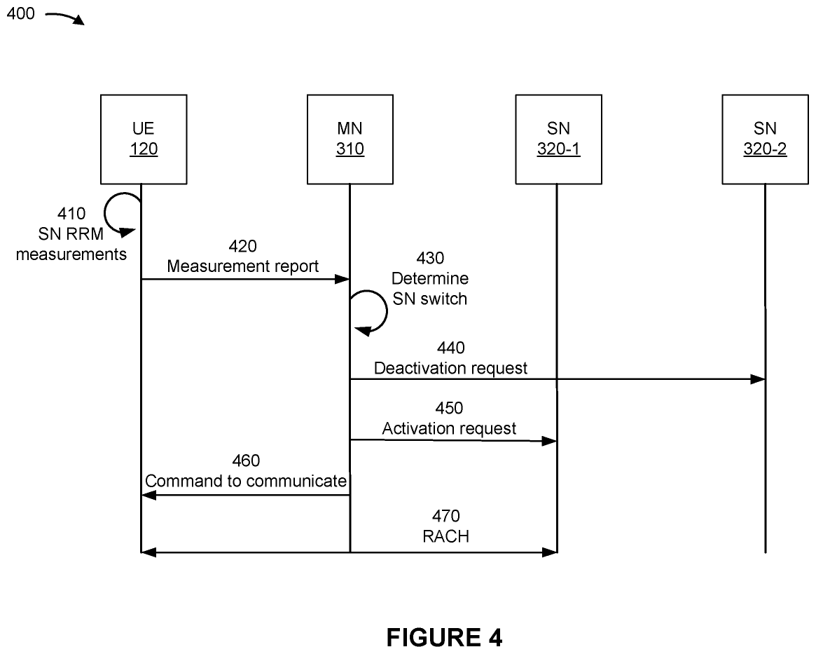

FIG. 4 is a diagram illustrating an example 400 of low latency switching between SNs. As shown in FIG. 4, the UE 120 may switch between the multiple SNs 320 for dual connectivity communications based on a determination made by the MN 310. Moreover, the UE 120 may switch between the multiple SNs 320 in accordance with the configuration for the multiple SNs 320, as described in more detail above in connection with FIG. 3. Furthermore, as shown in FIG. 4, the source SN 320-2 may be active, and the target SN 320-1 may be inactive, in accordance with example 300 of FIG. 3.

As shown by reference number 410, the UE 120 may obtain measurements relating to the multiple SNs 320, as described in more detail above in connection with FIG. 3. The UE 120 may obtain the measurements in accordance with respective measurement configurations for the multiple SNs 320, as described in more detail above in connection with FIG. 3. Moreover, the UE 120 may obtain the measurements after performing the RACH procedure of FIG. 3.

In some aspects, the UE 120 may monitor (to obtain measurements) at least one inactive SN of the multiple SNs 320 configured for the UE 120. For example, when the source SN 320-2 is active, the UE 120 may periodically monitor the inactive target SN 320-1 to obtain RRM measurements or RLM measurements in accordance with a measurement configuration for the target SN 320-1. In some aspects, the UE 120 may obtain RRM measurements from the inactive target SN 320-1 according to a different periodicity or a different quantity of samples than the UE 120 uses to obtain RRM measurements from the active source SN 320-2. Moreover, the UE 120 may monitor the inactive target SN 320-1 to obtain the measurements without transmitting or receiving communications from the inactive target SN 320-1 (for example, without monitoring a physical downlink control channel of the inactive target SN 320-1). In this way, the UE 120 may monitor inactive SNs 320 of the multiple SNs 320 configured to the UE 120 with reduced power consumption.

In some aspects, when monitoring the inactive target SN 320-1 to obtain RRM measurements or RLM measurements, the UE 120 may monitor a primary secondary cell (PSCell) of the inactive target SN 320-1. In some aspects, the RRM measurements or RLM measurements may relate to the PSCell or to a particular beam of the inactive target SN 320-1.

As shown by reference number 420, the UE 120 may transmit, and the MN 310 may receive, measurement reports relating to the measurements obtained by the UE 120 (for example, RRM measurements or RLM measurements). The UE 120 may transmit the measurement reports in accordance with respective measurement configurations for the multiple SNs 320, as described in more detail above in connection with FIG. 3. In some aspects, the UE 120 may transmit measurement reports associated with at least one inactive SN of the multiple SNs 320 configured to the UE 120. For example, when the source SN 320-2 is active, the UE 120 may periodically transmit measurement reports associated with the inactive target SN 320-1 in accordance with a measurement configuration for the target SN 320-1. The measurement reports may enable the MN 310 to determine whether to switch between the multiple SNs 320 (for example, deactivate the active source SN 320-2 and activate the inactive target SN 320-1).

As shown by reference number 430, the MN 310 may determine to switch the SN 320 that is providing dual connectivity with the MN 310. For example, the MN 310 may determine to deactivate the active source SN 320-2 and activate the inactive target SN 320-1. The MN 310 may select, for activation, an inactive SN (for example, the inactive target SN 320-1) of the multiple SNs 320 configured to the UE 120 based on the measurement reports (for example, RRM measurements) received from the UE 120. For example, the MN 310 may determine to deactivate the active source SN 320-2 and activate the inactive target SN 320-1 based on the measurement reports indicating that the target SN 320-1 is providing a stronger signal to the UE 120 than the source SN 320-2.

In some aspects, the MN 310 may determine an updated configuration of multiple SNs 320 that are candidates to provide dual connectivity with the MN 310 based on the measurement reports. For example, the MN 310 may determine an updated configuration that excludes SNs 320 that are providing a weak signal (for example, a signal below a threshold value) to the UE 120. The updated configuration also may identify resources, associated with a contention-free RACH procedure, for each respective SN 320 of the multiple SNs 320 of the updated configuration.

In some cases, an RLM measurement of a measurement report may indicate radio link failure between the UE 120 and an SN 320 of the multiple SNs 320 configured to the UE 120. In such a case, the MN 310 may release the SN 320 from the multiple SNs 320. The MN 310 may also transmit to the UE 120 an updated configuration that excludes the released SN 320. Additionally, or alternatively, the UE 120 may cease monitoring the released SN 320 based on detecting the radio link failure. In some cases, the released SN 320 may be an active SN 320 (for example, the source SN 320-2), and the MN 310 may select an inactive SN 320 (for example, the target SN 320-1) of the multiple SNs configured to the UE 120 to provide dual connectivity with the MN 310.

As shown by reference number 440, the MN 310 may transmit a deactivation request (for example, an SgNB request) to the active source SN 320-2. For example, based on determining to switch the SN 320 that is providing dual connectivity with the MN 310, the MN 310 may transmit a deactivation request to the active source SN 320-2. The deactivation request may cause deactivation of the source SN 320-2. In some cases, the MN 310 may maintain downlink time synchronization with the source SN 320-2 after deactivation.

As shown by reference number 450, the MN 310 may transmit an activation request (for example, an SgNB request) to the inactive target SN 320-1 based on selecting the inactive target SN 320-1 for activation. An activation request may cause activation of the target SN 320-1 for dual connectivity with the MN 310.

As shown by reference number 460, the MN 310 may transmit (for example, via DCI, RRC signaling, or a MAC-CE), and the UE 120 may receive, a command to communicate via the activated target SN 320-1. For example, the command may indicate that the UE 120 is to switch from the source SN 320-2, which was previously providing dual connectivity with the MN 310, to the target SN 320-1, which was selected to provide dual connectivity with the MN 310. The switch between SNs 320 may occur with reduced latency based on the configuration for the multiple SNs 320 retained by the UE 120, as described in more detail above in connection with FIG. 3.

In some aspects, the MN 310 may transmit the command to communicate via the activated target SN 320-1 prior to a role switch between the MN 310 and the activated target SN 320-1. For example, the MN 310 may transmit the command based on determining that poor radio conditions existed (for example, an RRM measurement is below a threshold value) between the MN 310 and the previously-active source SN 320-2. Thereafter, the MN 310 may cause (via a request to the activated target SN 320-1) a role switch between the MN 310 and the activated target SN 320-1, and transmit a configuration for the role switch to the UE 120.

As shown by reference number 470, the UE 120, in response to the command, may perform a RACH procedure to establish a connection with the activated target SN 320-1. For example, the UE 120 may perform a RACH procedure to establish a connection with the activated target SN 320-1 based on receiving a command to communicate via the activated target SN 320-1. Accordingly, the UE 120 may switch to the activated target SN 320-1 for dual connectivity with the MN 310. Moreover, during a switch between SNs 320, there is no packet data convergence protocol anchor change because the configuration for the multiple SNs 320 provides respective bearer configurations for the multiple SNs 320.

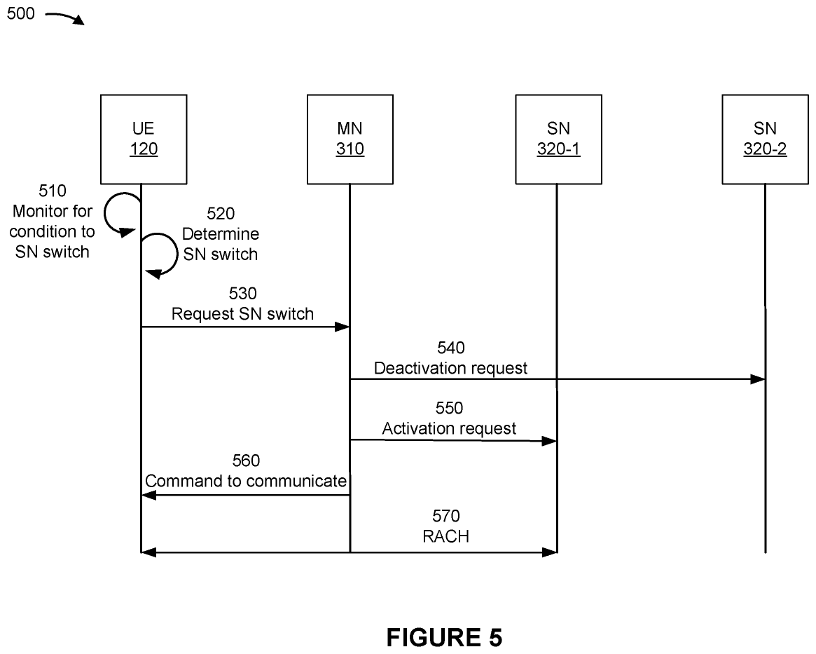

FIG. 5 is a diagram illustrating an example 500 of low latency switching between SNs. As shown in FIG. 5, the UE 120 may switch between the multiple SNs 320 for dual connectivity communications based on a determination made by the UE 120. Moreover, the UE 120 may switch between the multiple SNs 320 in accordance with the configuration for the multiple SNs 320, as described in more detail above in connection with FIG. 3. Furthermore, as shown in FIG. 5, the source SN 320-2 may be active, and the target SN 320-1 may be inactive, in accordance with example 300 of FIG. 3.

As shown by reference number 510, the UE 120 may monitor the multiple SNs 320 in order to detect an occurrence of a measurement condition specified in the configuration for the multiple SNs 320. For example, the UE 120 may obtain measurements relating to the multiple SNs 320, as described in more detail above in connection with FIG. 3. The UE 120 may obtain the measurements in accordance with respective measurement configurations for the multiple SNs 320, as described in more detail above in connection with FIG. 3. Moreover, the UE 120 may obtain the measurements after the RACH procedure of FIG. 3. In some aspects, the UE 120 may monitor (to obtain measurements) at least one inactive SN of the multiple SNs 320 configured to the UE 120. For example, when the source SN 320-2 is active, the UE 120 may periodically monitor the target SN 320-1 to obtain RRM measurements or RLM measurements in accordance with a measurement configuration for the target SN 320-1.

As shown by reference number 520, the UE 120 may determine to switch the SN 320 that is providing dual connectivity with the MN 310. For example, the UE 120 may determine to deactivate the active source SN 320-2 and activate the inactive target SN 320-1.

The UE 120 may determine to deactivate the active source SN 320-2 and activate an inactive SN (for example, the inactive target SN 320-1) based on detecting that one or more measurements relating to the multiple SNs 320 satisfy the measurement condition. The measurement condition may include one or more threshold values for one or more RRM measurements associated with the multiple SNs 320. Thus, for example, the UE 120 may determine to deactivate the active source SN 320-2 when a particular RRM measurement (for example, RSRP, RSRQ, SNR, SINK) for the active source SN 320-2 falls below a threshold value. Additionally, the UE 120 may select, for activation, an inactive SN 320 (for example, the inactive target SN 320-1) of the multiple SNs 320 configured to the UE 120 when one or more RRM measurements associated with the inactive SN 320 exceed a threshold value, or the inactive SN 320 has a highest RRM measurement among the inactive SNs 320. Additionally, the UE 120 may determine to deactivate the active source SN 320-2 and activate an inactive SN 320 (for example, inactive target SN 320-1) based on determining that one or more RRM measurements for the inactive SN 320 exceed corresponding RRM measurements for the active source SN 320-2. For example, the UE 120 may determine to deactivate the active source SN 320-2 and activate the inactive target SN 320-1 based on determining that the target SN 320-1 is providing a stronger signal to the UE 120 than the source SN 320-2.

As shown by reference number 530, the UE 120 may transmit, and the MN 310 may receive, a request to switch SNs 320 for providing dual connectivity with the MN 310. The UE 120 may transmit (for example, in a physical uplink shared channel) the request to switch SNs 320 via a MAC CE or via a release assistance indication. The request to switch SNs 320 may identify the inactive target SN 320-1 selected by the UE 120. In some aspects, the request to switch SNs 320 also may identify a particular beam (by beam index) of the selected inactive target SN 320-1. The particular beam may be a beam of the selected inactive target SN 320-1 that is providing a strongest signal to the UE 120. In some aspects, the request to switch SNs 320 also may provide a measurement report relating to the selected inactive target SN 320-1. For example, the measurement report may identify RRM measurements relating to the selected inactive target SN 320-1.

As shown by reference number 540, the MN 310 may transmit a deactivation request (for example, an SgNB request) to the active source SN 320-2, as described in more detail above in connection with FIG. 4. For example, the MN 310 may transmit the deactivation request based on receiving the request to switch SNs 320 transmitted by the UE 120.

As shown by reference number 550, the MN 310 may transmit an activation request (for example, an SgNB request) to the selected inactive target SN 320-1, as described in more detail above in connection with FIG. 4. For example, the activation request may cause activation of the selected inactive target SN 320-1. In some aspects, the activation request may include information associated with the particular beam indicated in the request to switch SNs 320 or the measurement report provided in the request to switch SNs 320. The particular beam or the measurement report may enable the activated target SN 320-1 to select resources for a contention-free RACH procedure of the UE 120.

As shown by reference number 560, the MN 310 may transmit (for example, via DCI, RRC signaling, or a MAC CE), and the UE 120 may receive, a command to communicate via the activated target SN 320-1, as described in more detail above in connection with FIG. 4. In some aspects, the MN 310 may transmit the command to communicate via the activated target SN 320-1 prior to a role switch between the MN 310 and the activated target SN 320-1. For example, the MN 310 may transmit the command based on receiving an indication from the UE 120 (for example, in the request to switch SNs 320) that poor radio conditions exist (for example, an RRM measurement is below a threshold value) between the MN 310 and the previously-active source SN 320-2. Thereafter, the MN 310 may cause (via a request to the activated target SN 320-1) a role switch between the MN 310 and the activated target SN 320-1, and transmit a configuration for the role switch to the UE 120.

As shown by reference number 570, the UE 120, in response to the command, may perform a RACH procedure to establish a connection with the activated target SN 320-1), as described in more detail above in connection with FIG. 4. In some aspects, the RACH procedure may employ resources selected by the activated target SN 320-1 according to the particular beam indicated in the activation request or the measurement report provided in the activation request.

FIG. 6 is a diagram illustrating an example process 600 performed, for example, by a UE, in accordance with various aspects of the present disclosure. The example process 600 shows where a UE, such as the UE 120, performs operations associated with low latency switching between SNs.

As shown in FIG. 6, in some aspects, the process 600 may include receiving a configuration for a plurality of SNs that are candidates to provide dual connectivity with an MN (block 610). For example, the UE (for example, using receive processor 258, controller/processor 280, memory 282) may receive a configuration for a plurality of SNs that are candidates to provide dual connectivity with an MN, as described above.

As shown in FIG. 6, in some aspects, the process 600 may include receiving a command to communicate via an SN of the plurality of the SNs (block 620). For example, the UE (for example, using receive processor 258, controller/processor 280, memory 282) may receive a command to communicate via an SN of the plurality of the SNs, as described above.

As shown in FIG. 6, in some aspects, the process 600 may include communicating via the MN and the SN (block 630). For example, the UE (for example, using receive processor 258, transmit processor 264, controller/processor 280, memory 282) may communicate via the MN and the SN, as described above.

The process 600 may include additional aspects, such as any single aspect or any combination of aspects described below and/or in connection with one or more other processes described elsewhere herein.

In a first aspect, the configuration identifies a measurement configuration for each respective SN of the plurality of the SNs. In a second aspect, alone or in combination with the first aspect, the process 600 further includes transmitting RRM measurements associated with the plurality of the SNs to enable the MN to select the SN for activation. In a third aspect, alone or in combination with one or more of the first and second aspects, the process 600 further includes receiving an updated configuration for a plurality of SNs that are candidates to provide dual connectivity with the MN based on the RRM measurements, and the updated configuration identifies resources, associated with a contention-free random access channel procedure, for each respective SN of the plurality of the SNs.

In a fourth aspect, alone or in combination with one or more of the first through third aspects, the configuration identifies a measurement condition that is to cause a request to activate a particular SN of the plurality of the SNs. In a fifth aspect, alone or in combination with one or more of the first through fourth aspects, the process 600 further includes transmitting a request to activate the SN based on a determination that a measurement condition for activating a particular SN of the plurality of the SNs is satisfied, and the command to communicate via the SN is based on the request. In a sixth aspect, alone or in combination with one or more of the first through fifth aspects, the request identifies a particular beam of the SN.

In a seventh aspect, alone or in combination with one or more of the first through sixth aspects, the command to communicate via the SN is received prior to a role switch between the MN and the SN. In an eighth aspect, alone or in combination with one or more of the first through seventh aspects, the process 600 further includes transmitting an indication of radio link failure in the SN, and receiving a command to communicate via another SN of the plurality of the SNs.

In a ninth aspect, alone or in combination with one or more of the first through eighth aspects, the process 600 further includes obtaining measurements associated with at least one of a remainder of the SNs of the plurality of the SNs while communicating via the MN and the SN. In a tenth aspect, alone or in combination with one or more of the first through ninth aspects, the measurements are at least one of radio resource management measurements or radio link monitoring measurements.

Although FIG. 6 shows example blocks of the process 600, in some aspects, the process 600 may include additional blocks, fewer blocks, different blocks, or differently arranged blocks than those depicted in FIG. 6. Additionally, or alternatively, two or more of the blocks of the process 600 may be performed in parallel.

FIG. 7 is a diagram illustrating an example process 700 performed, for example, by a base station, in accordance with various aspects of the present disclosure. The example process 700 shows where a base station, such as the base station 110, performs operations associated with low latency switching between SNs.

As shown in FIG. 7, in some aspects, the process 700 may include transmitting, to a UE, a configuration for a plurality of SNs that are candidates to provide dual connectivity with the MN (block 710). For example, the base station (for example, using transmit processor 220, controller/processor 240, memory 242) may transmit, to a UE, a configuration for a plurality of SNs that are candidates to provide dual connectivity with the MN, as described above.

As shown in FIG. 7, in some aspects, the process 700 may include causing activation of an SN of the plurality of the SNs for dual connectivity with the MN (block 720). For example, the base station (for example, using transmit processor 220, controller/processor 240, memory 242) may cause activation of an SN of the plurality of the SNs for dual connectivity with the MN, as described above.

As shown in FIG. 7, in some aspects, the process 700 may include transmitting, to the UE, a command to communicate via the SN of the plurality of the SNs (block 730). For example, the base station (for example, using transmit processor 220, controller/processor 240, memory 242) may transmit, to the UE, a command to communicate via the SN of the plurality of the SNs, as described above.

The process 700 may include additional aspects, such as any single aspect or any combination of aspects described below and/or in connection with one or more other processes described elsewhere herein.

In a first aspect, the configuration identifies a measurement configuration for each respective SN of the plurality of the SNs. In a second aspect, alone or in combination with the first aspect, the process 700 further includes receiving RRM measurements associated with the plurality of the SNs, and causing activation of the SN is based on the RRM measurements. In a third aspect, alone or in combination with one or more of the first and second aspects, the process 700 further includes transmitting an updated configuration for a plurality of SNs that are candidates to provide dual connectivity with the MN based on the RRM measurements, and the updated configuration identifies resources, associated with a contention-free random access channel procedure, for each respective SN of the plurality of the SNs.

In a fourth aspect, alone or in combination with one or more of the first through third aspects, the configuration identifies a measurement condition that is to cause a request to activate a particular SN of the plurality of the SNs. In a fifth aspect, alone or in combination with one or more of the first through fourth aspects, the process 700 further comprises receiving a request to activate the SN, and causing activation of the SN is based on the request. In a sixth aspect, alone or in combination with one or more of the first through fifth aspects, the request identifies a particular beam of the SN.

In a seventh aspect, alone or in combination with one or more of the first through sixth aspects, the command to communicate via the SN is transmitted prior to a role switch between the MN and the SN.

In an eighth aspect, alone or in combination with one or more of the first through seventh aspects, the process 700 further includes receiving an indication of radio link failure in the SN, causing activation of another SN of the plurality of the SNs, and transmitting a command to communicate via the other SN of the plurality of the SNs. In a ninth aspect, alone or in combination with one or more of the first through eighth aspects, the process 700 further includes causing deactivation of another SN of the plurality of the SNs prior to causing activation of the SN.

In a tenth aspect, alone or in combination with one or more of the first through ninth aspects, the process 700 further includes transmitting a request to a CU to configure the plurality of the SNs for dual connectivity with the MN. In an eleventh aspect, alone or in combination with one or more of the first through tenth aspects, the process 700 further includes receiving information associated with the plurality of the SNs from the central unit, and the configuration is based on the information.

Although FIG. 7 shows example blocks of the process 700, in some aspects, the process 700 may include additional blocks, fewer blocks, different blocks, or differently arranged blocks than those depicted in FIG. 7. Additionally, or alternatively, two or more of the blocks of the process 700 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving a configuration for a plurality of secondary nodes (SNs) that are candidates to provide dual connectivity with a master node (MN);
receiving a command to communicate via an SN of the plurality of the SNs; and
communicating via the MN and the SN.

2. The method of claim 1, wherein the configuration identifies a measurement configuration for each respective SN of the plurality of the SNs.

3. The method of claim 1, further comprising transmitting radio resource management (RRM) measurements associated with the plurality of the SNs to enable the MN to select the SN for activation.

4. The method of claim 3, further comprising receiving an updated configuration for a plurality of SNs that are candidates to provide dual connectivity with the MN based on the RRM measurements, wherein the updated configuration identifies resources, associated with a contention-free random access channel procedure, for each respective SN of the plurality of the SNs.

5. The method of claim 1, wherein the configuration identifies a measurement condition that is to cause a request to activate a particular SN of the plurality of the SNs.

6. The method of claim 1, further comprising transmitting a request to activate the SN based on a determination that a measurement condition for activating a particular SN of the plurality of the SNs is satisfied, wherein the command to communicate via the SN is based on the request.

7. The method of claim 6, wherein the request identifies a particular beam of the SN.

8. The method of claim 1, wherein the command to communicate via the SN is received prior to a role switch between the MN and the SN.

9. The method of claim 1, further comprising transmitting an indication of radio link failure in the SN; and
receiving a command to communicate via another SN of the plurality of the SNs.

10. The method of claim 1, further comprising obtaining measurements associated with at least one of a remainder of the SNs of the plurality of the SNs while communicating via the MN and the SN.

11. The method of claim 10, wherein the measurements are at least one of radio resource management measurements or radio link monitoring measurements.

12. A method of wireless communication performed by a base station that is a master node (MN), comprising:
transmitting, to a user equipment (UE), a configuration for a plurality of secondary nodes (SNs) that are candidates to provide dual connectivity with the MN;
causing activation of an SN of the plurality of the SNs for dual connectivity with the MN; and
transmitting, to the UE, a command to communicate via the SN of the plurality of the SNs.

13. The method of claim 12, wherein the configuration identifies a measurement configuration for each respective SN of the plurality of the SNs.

14. The method of claim 12, further comprising receiving radio resource management (RRM) measurements associated with the plurality of the SNs, wherein causing activation of the SN is based on the RRM measurements.

15. The method of claim 14, further comprising transmitting an updated configuration for a plurality of SNs that are candidates to provide dual connectivity with the MN based on the RRM measurements, wherein the updated configuration identifies resources, associated with a contention-free random access channel procedure, for each respective SN of the plurality of the SNs.

16. The method of claim 12, wherein the configuration identifies a measurement condition that is to cause a request to activate a particular SN of the plurality of the SNs.

17. The method of claim 12, further comprising receiving a request to activate the SN, wherein causing activation of the SN is based on the request.

18. The method of claim 17, wherein the request identifies a particular beam of the SN.

19. The method of claim 12, wherein the command to communicate via the SN is transmitted prior to a role switch between the MN and the SN.

20. The method of claim 12, further comprising receiving an indication of radio link failure in the SN;
causing activation of another SN of the plurality of the SNs; and
transmitting a command to communicate via the other SN of the plurality of the SNs.

21. The method of claim 12, further comprising causing deactivation of another SN of the plurality of the SNs prior to causing activation of the SN.

22. The method of claim 12, further comprising transmitting a request to a central unit (CU) to configure the plurality of the SNs for dual connectivity with the MN.

23. The method of claim 22, further comprising receiving information associated with the plurality of the SNs from the central unit, wherein the configuration is based on the information.

24-40. (canceled)

41. A user equipment (UE) for wireless communication, comprising:
a memory; and
one or more processors operatively coupled to the memory, the memory and the one or more processors configured to:
receive a configuration for a plurality of secondary nodes (SNs) that are candidates to provide dual connectivity with a master node (MN);
receive a command to communicate via an SN of the plurality of the SNs; and
communicate via the MN and the SN.

42. The UE of claim 41, wherein the memory and the one or more processors are further configured to:
transmit radio resource management (RRM) measurements associated with the plurality of the SNs to enable the MN to select the SN for activation.

43. The UE of claim 42, wherein the memory and the one or more processors are further configured to:
receive an updated configuration for a plurality of SNs that are candidates to provide dual connectivity with the MN based on the RRM measurements, wherein the updated configuration identifies resources, associated with a contention-free random access channel procedure, for each respective SN of the plurality of the SNs.

44. The UE of claim 41, wherein the memory and the one or more processors are further configured to:
transmit a request to activate the SN based on a determination that a measurement condition for activating a particular SN of the plurality of the SNs is satisfied, wherein the command to communicate via the SN is based on the request.

45. A base station that is a master node (MN) for wireless communication, comprising:
a memory; and
one or more processors operatively coupled to the memory, the memory and the one or more processors configured to:
transmit, to a user equipment (UE), a configuration for a plurality of secondary nodes (SNs) that are candidates to provide dual connectivity with the MN;
cause activation of an SN of the plurality of the SNs for dual connectivity with the MN; and
transmit, to the UE, a command to communicate via the SN of the plurality of the SNs.

46. The base station of claim 45, wherein the memory and the one or more processors are further configured to:
receive radio resource management (RRM) measurements associated with the plurality of the SNs, wherein causing activation of the SN is based on the RRM measurements.

47. The base station of claim 45, wherein the memory and the one or more processors are further configured to:
transmit an updated configuration for a plurality of SNs that are candidates to provide dual connectivity with the MN based on the RRM measurements, wherein the updated configuration identifies resources, associated with a contention-free random access channel procedure, for each respective SN of the plurality of the SNs.
